(19) United States
(12) Patent Application Publication
(10) Pub. No.: US 2025/0300839 A1
(43) Pub. Date: Sep. 25, 2025

(54) BUSINESS PROCESSING METHOD AND APPARATUS FOR BLOCKCHAIN NETWORK, PRODUCT, DEVICE, AND MEDIUM

(71) Applicant: Tencent Technology (Shenzhen) Company Limited, Shenzhen (CN)

(72) Inventors: Hanqing Liu, Shenzhen (CN); Zongyou Wang, Shenzhen (CN); Yifang Shi, Shenzhen (CN); Gengliang Zhu, Shenzhen (CN); Qucheng Liu, Shenzhen (CN); Zhiyong Liao, Shenzhen (CN)

(73) Assignee: Tencent Technology (Shenzhen) Company Limited, Shenzhen (CN)

(21) Appl. No.: 19/229,173

(22) Filed: Jun. 5, 2025

Related U.S. Application Data
(63) Continuation of application No. PCT/CN2023/131758, filed on Nov. 15, 2023.

(30) Foreign Application Priority Data
May 17, 2023 (CN) 202310563531.0

(51) Int. Cl. H04L 9/32; H04L 9/00; H04L 9/08

(52) U.S. Cl. CPC H04L 9/3247; H04L 9/008; H04L 9/0822

(57) ABSTRACT

A method, apparatus, and computer-readable storage medium for transaction processing in a blockchain network. The method includes receiving a first transaction from a client via a target processing node, and extracting information of a target type that is not needed during consensus processing or post-consensus execution. A local contract deployed in the target processing node processes this extracted information to obtain a processing result. A transition transaction is generated based on the processing result and remaining information from the first transaction, and transmitted to the client. The transition transaction is signed cooperatively using private key fragments stored in both the client and processing node to obtain a transaction signature. A second transaction is then generated based on this signature and the transition transaction, and transmitted to the consensus network for consensus processing.

### CROSS-REFERENCE TO RELATED APPLICATIONS

The disclosure is a continuation application of International Application No. PCT/CN2023/131758 filed on Nov. 15, 2023 which claims priority to Chinese Patent Application No. 202310563531.0, filed with the China National Intellectual Property Administration on May 17, 2023, the disclosures of each being incorporated by reference herein in their entireties.

### FIELD

The disclosure relates to the technical field of blockchains, a method for transaction processing in a blockchain network, an apparatus for transaction processing in a blockchain network, a computer program product, a computer device, and a computer-readable storage medium.

### BACKGROUND

In the related art, a processing node receives transactions initiated by clients and performs verification before transmitting them to a consensus network. This architecture concentrates the substantial processing of client-initiated transactions entirely within the consensus network. When multiple clients simultaneously initiate numerous transactions, the processing load on the consensus network becomes extremely high, potentially causing processing congestion that significantly reduces the transaction processing performance and throughput of the blockchain network. The current approach lacks effective mechanisms to distribute transaction processing workloads, fails to provide adequate privacy protection for sensitive transaction information, and struggles to maintain transaction integrity when portions of a transaction require processing outside the consensus network, highlighting the need for improved transaction processing methods that enhance performance while preserving security.

### SUMMARY

Provided are a method and apparatus for transaction processing in a blockchain network, a device, a storage medium, and a program product, which can implement efficient transaction processing by separating information types and performing pre-consensus processing.

According to some embodiments, a method for transaction processing in a blockchain network, performed by a computer device, includes: receiving, from a target processing node in a processing network of the blockchain network, a first transaction transmitted by a client; extracting, from the first transaction, information of a target type comprising information that is not used during consensus processing by a consensus network of the blockchain network or during execution after successful consensus; invoking a local contract deployed in the target processing node to perform information processing on the information of the target type to obtain a processing result; generating a transition transaction based on the processing result and other information from the first transaction excluding the information of the target type; transmitting the transition transaction to the client; signing, in cooperation with the client, the transition transaction based on private key fragments stored in the client and the target processing node to obtain a first transaction signature; and generating a second transaction based on the first transaction signature and the transition transaction, and transmitting the second transaction to the consensus network to initiate the consensus network to perform consensus on the second transaction.

According to some embodiments, an apparatus for transaction processing in a blockchain network, includes: at least one memory configured to store program code; and at least one processor configured to read the program code and operate as instructed by the program code, the program code including: receiving code configured to cause at least one of the at least one processor to receive, from a target processing node in a processing network of the blockchain network, a first transaction transmitted by a client; extracting code configured to cause at least one of the at least one processor to extract, from the first transaction, information of a target type comprising information that is not used during consensus processing by a consensus network of the blockchain network or during execution after successful consensus; invoking code configured to cause at least one of the at least one processor to invoke a local contract deployed in the target processing node to perform information processing on the information of the target type to obtain a processing result; generating code configured to cause at least one of the at least one processor to generate a transition transaction based on the processing result and other information from the first transaction excluding the information of the target type; transmitting code configured to cause at least one of the at least one processor to transmit the transition transaction to the client; signing code configured to cause at least one of the at least one processor to sign, in cooperation with the client, the transition transaction based on private key fragments stored in the client and the target processing node to obtain a first transaction signature; and transaction code configured to cause at least one of the at least one processor to generate a second transaction based on the first transaction signature and the transition transaction, and transmit the second transaction to the consensus network to initiate the consensus network to perform consensus on the second transaction.

According to some embodiments, a non-transitory computer-readable storage medium, storing computer code which, when executed by at least one processor, causes the at least one processor to at least: receive, from a target processing node in a processing network of a blockchain network, a first transaction transmitted by a client; extract, from the first transaction, information of a target type comprising information that is not used during consensus processing by a consensus network of the blockchain network or during execution after successful consensus; invoke a local contract deployed in the target processing node to perform information processing on the information of the target type to obtain a processing result; generate a transition transaction based on the processing result and other information from the first transaction excluding the information of the target type; transmit the transition transaction to the client; sign, in cooperation with the client, the transition transaction based on private key fragments stored in the client and the target processing node to obtain a first transaction signature; and generate a second transaction based on the first transaction signature and the transition transaction, and transmit the second transaction to the consensus network to initiate the consensus network to perform consensus on the second transaction.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic structural diagram of a network architecture of business processing according to some embodiments.

FIG. 2 is a schematic diagram of a scene of business processing according to some embodiments.

FIG. 3 is a schematic flowchart of a business processing method for a blockchain network according to some embodiments.

FIG. 4 is a schematic diagram of a scene of key interaction related to private key fragments according to some embodiments.

FIG. 5 is a schematic diagram of a scene of generating a transition business according to some embodiments.

FIG. 6 is a schematic diagram of a scene of generating a second business according to some embodiments.

FIG. 7 is a schematic flowchart of a contract deployment method according to some embodiments.

FIG. 8 is a schematic flowchart of deploying a local contract according to some embodiments.

FIG. 9 is a schematic structural diagram of a business processing apparatus for a blockchain network according to some embodiments.

FIG. 10 is a schematic structural diagram of a computer device according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

Hereinafter, related technical concepts involved in the disclosure will be described.
1. Blockchain:

The blockchain is a new application mode of computer technologies such as distributed data storage, peer-to-peer transmission, a consensus mechanism, and an encryption algorithm. The blockchain is essentially a decentralized database and includes a series of data blocks generated associatively through a cryptographic method. Each data block contains information of a batch of network businesses (such as transactions), which is configured for verifying the effectiveness of the information (anti-counterfeiting) and generating a next block. The blockchain may include a blockchain bottom platform, a platform product service layer, and an application service layer. The blockchain includes a series of blocks that are consecutive in an order of generation time. Once a new block is added to the blockchain, the new block is no longer removed. The block records recorded data submitted by a node in a blockchain system.
2. Smart contract:

The smart contract is an automated computer program that runs on the blockchain, and is configured for performing operations predefined under contract terms. These contracts are stored on the blockchain in a form of code and may be automatically executed by nodes on the blockchain. The smart contracts in the disclosure include the following local contract and business contract. The local contract (also referred to as a local smart contract): is a smart contract whose execution process does not participate in consensus. The local contract is executed only on a single business node (i.e., a single blockchain node). The business node is a blockchain node that does not participate in the consensus, and may be configured for storing business data on the blockchain.
3. Elliptic curve digital signature algorithm (ECDSA) m-n multi-signature algorithm:

n and m are both positive integers, n is the number of participants, and m is the minimum number of participants among the n participants that can sign a business. The n participants perform key interaction (also referred to as key negotiation, for example, key negotiation about a node private key), and after the key interaction is completed, the parties participating in the key interaction each has a private key fragment (for example, a private key fragment of the node private key). All participants may save the same global public key (for example, a node public key corresponding to the node private key). At the signing stage, any m participants in the n participants may sign a business, and an obtained business signature is consistent with a signature obtained by signing the business using the complete node private key. The business signature may be verified through the global public key (node public key).
4. Cloud technology:

The cloud technology is a hosting technology that unifies a series of resources such as hardware, software, and networks in a wide area network or a local area network to realize data calculation, storage, processing, and sharing. The cloud technology, a general term for network technology, information technology, integration technology, management platform technology, and application technology that are applied based on a commercial mode of cloud computing, may form a resource pool and may be used on demand, which is flexible and convenient. The cloud computing technology will become an important support. The background service of a technical network system requires many computing and storage resources, for example, video websites, image websites, and more portal websites. With the rapid development and application of the Internet industry, each item may have its own identification mark in the future, and the identification marks may be transmitted to a backend system for logical processing. Data of different levels is processed separately, and all kinds of industry data require a strong system support, which can be realized only through the cloud computing. Application of the cloud technology in the disclosure includes: data interaction performed between the client and the business node and between the business node and the consensus node through the “cloud”.

Throughout this disclosure, the term “business” is used to refer to blockchain transactions, and data records processed within the blockchain network. For clarity and consistency with blockchain terminology, the terms “business,” “transaction,” and “blockchain operation” “data record,” may be used interchangeably within this disclosure and the claims. Certain terms may be used interchangeably while maintaining their technical meaning within the blockchain context. The term “transaction” may also be referred to as “business” throughout the disclosure, with both terms describing operations that require processing and consensus within the blockchain network. Similarly, “target processing node” and “target business node” both refer to the network component that performs preliminary transaction processing before consensus validation. The terms “transaction contract” and “business contract”, “transaction signature” and “business signature” likewise refer to the same or similar components.

A “first business (i.e. first transaction)” may refer to an initial transaction submitted by a client; a “transition business” may refer to a modified transaction after preprocessing; and a “second business (i.e. second transaction)” may refer to another transaction submitted to the consensus network. Similarly, “business information” refers to transaction data or transaction information, “business network” refers to a transaction processing network, and “business node” refers to a transaction processing node within the blockchain architecture.

All business data (such as business information, transaction information, node private key, private key fragment, public key fragment, node public key, and other relevant data) acquired in the disclosure are acquired with the consent and authorization of an object (such as a user, institution, or enterprise) to which the business data belongs, and the acquisition, use, and processing of relevant data may comply with the relevant laws, regulations, and standards.

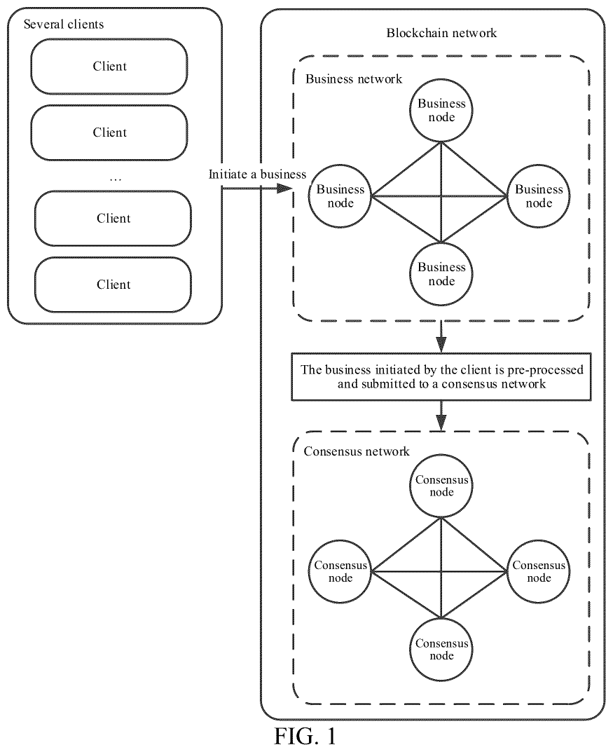

FIG. 1 is a schematic structural diagram of a network architecture of business processing according to some embodiments. As shown in FIG. 1, the network architecture may include several clients (which may be understood as a client set) and a blockchain network. The client may be a client used by a user, and the user may initiate a business to the blockchain network based on the used client. The blockchain network may contain a business network (i.e. a transaction network) and a consensus network. The business network may contain a plurality of business nodes, and the number of business nodes in the business network may be determined according to an actual application scene. This is not limited. Similarly, the consensus network may contain a plurality of consensus nodes, and the number of consensus nodes in the consensus network may further be determined according to an actual application scene. This is not limited.

The business node in the business network may be connected with the client of the user. In some embodiments, different business nodes may be connected with different clients, for example, several clients may be allocated to different business nodes for connection. The connection may be understood as exclusive connection, for example, the business of the client is responded to and processed by a business node connected with the client. In addition, in a subsequent embodiment, the business node and the connected client may perform key interaction on the private key fragment of the node private key of the business node so that the business node and the client each obtain the private key fragment of the node private key of the business node. In some embodiments, the key interaction refers to key negotiation, i.e., a process in which two (or more) parties negotiate a common key (which refers to the private key fragment of the node private key in the disclosure) through interaction. Through such embodiments, not only the business processing efficiency of the client may be improved, but also the utilization rate of node resources of the business nodes may be improved. For example, if the business network contains a business node 1, a business node 2, a business node 3, and a business node 4, and the client set includes a client 1 to a client 12, clients connected with the business node 1 may include the client 1 to the client 3, clients connected with the business node 2 may include the client 4 to the client 6,clients connected with the business node 3 may include the client 7 to the client 9, and clients connected with the business node 4 may include the client 10 to the client 12. In another implementation, different business nodes may be connected with the same client, which may be determined according to an actual application scene. This is not limited.

The business node in the business network and the consensus node in the consensus network both belong to blockchain nodes in the blockchain network, and the blockchain node may include a server. The server may be an independent physical server, may be a server cluster or a distributed system including a plurality of physical servers, or may be a cloud server providing cloud computing services such as a cloud service, a cloud database, cloud computing, a cloud function, cloud storage, a network service, cloud communication, a middleware service, a domain name service, a security service, a content distribution network (CDN), and a big data and artificial intelligence platform.

Since the business nodes process businesses of the connected clients using the same and independent principle, a process in which one business node (collectively referred to as a business node below) processes a business of one connected client (collectively referred to as a client below) is used as an example for description below.

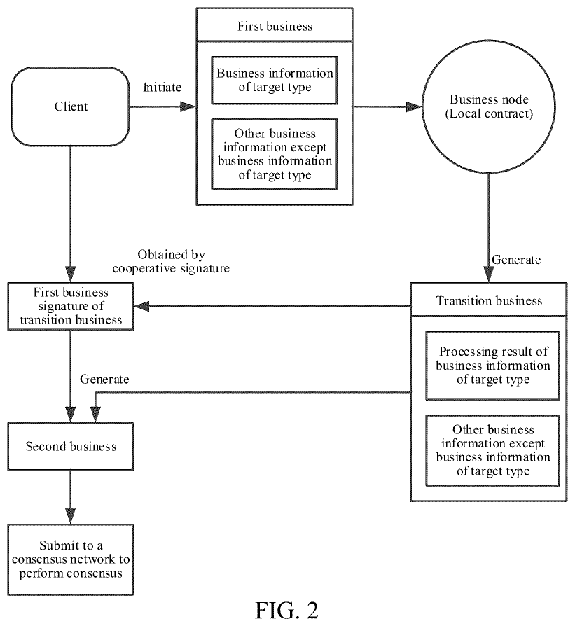

In the disclosure, the client may initiate a business to the business node, and the business node may correspondingly pre-process the business initiated by the client and submit a new business formed after pre-processing to the consensus node for consensus processing, as described below. The pre-processing herein refers to processing performed before consensus, and in the disclosure, refers to a process in which the business node performs information processing on business information of a target type before consensus is performed on the business. FIG. 2 is a schematic diagram of a scene of business processing according to some embodiments. As shown in FIG. 2, herein, a client may initiate a first business to a business node. The first business may include business information of a target type and other business information except the business information of the target type. The business information of the target type may refer to business information that is not witnessed by a consensus network. No witness refers to: business information that is not used in a process of performing consensus on a business by the consensus network; or business information that is not used in a process of executing the business after consensus on the business by the consensus network succeeds. That is, the existence or absence of the business information of the target type has no impact on a subsequent process of performing consensus on the business by the consensus network or a process of executing the business after consensus on the business succeeds.

A local contract (i.e., a local smart contract) configured for pre-processing the business is deployed in the business node. The business node may invoke the local contract deployed in the business node to perform information processing on the business information of the target type in the first business to obtain a processing result of the business information of the target type. The business node may generate a transition business (i.e. a transition transaction) based on the processing result of the business information of the target type and other business information in the first business except the business information of the target type. The transition business is a new business obtained after the business node pre-processes the first business. The business node and the connected client may each save a private key fragment of a node private key of the business node, and the private key fragment is obtained by key interaction between the business node and the connected client. Therefore, the business node may transmit the transition business to the client and sign, in cooperation with the client, the transition business based on the saved private key fragments to generate a business signature (which may be referred to as a first business signature) of the transition business. The business node may combine the first business signature and the transition business to generate a second business. The second business is a business that may be submitted to the consensus network to perform consensus. The business node may transmit the second business to the consensus network to cause the consensus network to perform consensus on the second business. After consensus on the second business succeeds in the consensus network, the consensus network may execute the second business and then upload the second business.

It can be learned from the foregoing that, some business logic (i.e., logic that performs information processing on the business information of the target type) that originally may be implemented in the consensus node may be implemented in the local contract of the business node, thereby reducing a load of the consensus node for performing business processing. Moreover, the business information of the target type is processed in the local contract of the business node. The local contract exists only in the business node to which the local contract belongs, and processing logic of the local contract for the business information of the target type is public (for example, the processing logic of the local contract may be disclosed on the blockchain). However, the processing process of the local contract for the business information of the target type is confidential (for example, the processing process exists only in the business node to which the local contract belongs) so that the business information of the target type exists only in the business node to which the local contract belongs and is not leaked to another blockchain node, thereby ensuring the privacy and security of the business information of the target type.

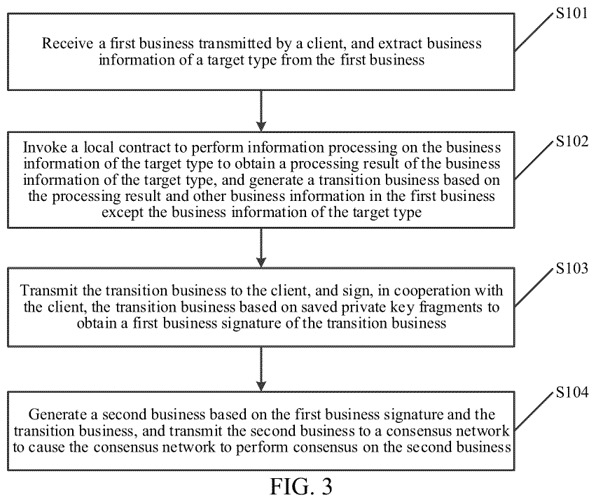

FIG. 3 is a schematic flowchart of a business processing method for a blockchain network according to some embodiments. The blockchain network may contain a business network and a consensus network. The business network may contain a plurality of business nodes, and the consensus network may contain a plurality of consensus nodes. The business node and the consensus node are both blockchain nodes. Any blockchain node may include one or more computer devices. The computer device may be a terminal device, a server, or another device. This is not limited. Any business node in the business network may be referred to as a target business node (i.e. a target processing node). The target business node may be a business node that has completed key interaction on a private key fragment with the client. A first business may be any business initiated by the client to a business node (i.e., the target business node) that has completed key interaction on the private key fragment with the client. The client may be a client of any user and is configured to initiate a business by the user. The method in this embodiment may be performed by the target business node. As shown in FIG. 3, the method may include the following operations.

Operation S101: Receive the first business transmitted by the client, and extract business information of a target type from the first business, the business information of the target type being business information that is not witnessed by the consensus network, for example, the business information of the target type being business information that is not used in a process of performing consensus on a business by the consensus network, or business information that is not used in a process of executing the business after consensus on the business by the consensus network succeeds.

The target business node may have a node private key (also referred to as a node key), and the node private key may be configured for performing signature encryption on a business of the target business node. In the disclosure, there may be one or more clients (i.e., clients with which the target business node may be connected for business processing). In the disclosure, the one or more clients may perform key interaction with the target business node together to obtain a private key fragment of the node private key. The node private key may be obtained by key interaction by the target business node and all connected clients (for example, obtained by performing key interaction through an ECDSA m-n multi-signature algorithm). After the key interaction is completed, any party (for example, the target business node or any client with which the target business node is connected) participating in the key interaction may save a private key fragment of the node private key. Illustratively, in the ECDSA m-n multi-signature algorithm involved herein, n may be equal to the number of parties participating in key interaction, i.e., a sum of the number of all clients with which the target business node is connected and the number of target business nodes; m may be equal to 2. Parties participating in key interaction only save the private key fragments, and none of the parties stores a complete node private key to ensure the security of the node private key. In addition, m is set to 2 so that any two parties of n parties participating in key interaction may realize a joint signature on the business (equivalent to signing the business through a complete node private key), for example, any client may perform data interaction with the target business node to sign the business (a transition business described below). m is equal to 2. The node private key may be restored through two private key fragments (i.e., any two private key fragments) of any two parties participating in key interaction (for example, the two private key fragments are added to obtain the node private key), and private key fragments saved by the parties are kept confidential from each other.

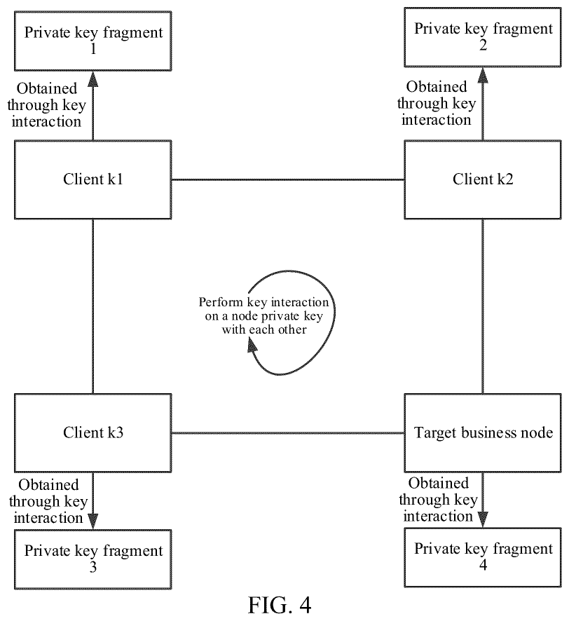

FIG. 4 is a schematic diagram of a scene of key interaction related to private key fragments according to some embodiments. As shown in FIG. 4, the foregoing n may be equal to 4, for example, n is equal to a sum of the three clients (including a client k1, a client k2, and a client k3) herein and the number of target business nodes. The three clients and the target business node may perform multiple rounds of key interaction on a private key fragment of a node private key of the target business node. After the key interaction is completed, each party may acquire a private key fragment of the node private key of the target business node. In this case, the client k1 may obtain a private key fragment 1, the client k2 may obtain a private key fragment 2, the client k3 may obtain a private key fragment 3, and the target business node may obtain a private key fragment 4.

Principles of performing data interaction between the clients and the target business node to process the business are the same and independent of each other. Therefore, the disclosure is described using a process of performing data interaction between a client and the target business node to process the business of the client (collectively referred to as a client below) as an example. Only in a process of performing key interaction of the private key fragment of the node private key, there may be a plurality of clients. Types of the first business in the disclosure may further be different according to different application scenes. For example, in a data notarization application scene, the first business may be a data notarization business. In an application scene of resource transfer, the first business may be a resource transfer business. In an application scene of resource issuance, the first business may be a resource issuance business, and the like. A business type of the first business may be determined according to an actual application scene. This is not limited. The disclosure may be applied to all related application scenes in which a business may be cooperatively processed by the business node and the consensus node.

Furthermore, a local contract (i.e., a local smart contract) may be deployed in the target business node and may run only on the target business node. The local contract may be configured for processing business information of a target type in a business. For different application scenes, the business information of the target type may be different, and processing logic configured in the local contract for the business of the target type may further be different. The processing logic may be determined according to an actual application scene. The business information of the target type may be business information of a type that is not witnessed by a consensus network in a business. The business information of the target type may be business information that is not used in a process of performing consensus on a business by the consensus network or in a process of executing the business after consensus is performed. That is, the existence or absence of the business information of the target type has no impact on a subsequent process of performing consensus on the business by the consensus network or a process of executing the business after consensus on the business succeeds. For example, the first business may be a data notarization business initiated by the client, the business information of the target type may be identity information of the client in the first business, and the identity information may be configured for authenticating an identity of the client.

The target business node may receive the first business initiated by the client and extract the business information of the target type from the first business. In some embodiments, the target business node may further have a precondition for extracting the business information of the target type from the first business (for example, starting to perform business processing on the first business may have a precondition). For example: after the first business is successfully verified, the business information of the target type is allowed to be extracted from the first business.

The first business may contain a business signature, and the business signature may be referred to as a second business signature. The second business signature may be obtained after the client signs business information in the first business except the second business signature (for example, a hash value of the business information in the first business except the second business signature is encrypted) based on the private key fragment saved by the client. The second business signature is a signature of the first business. The private key fragment saved by the client and a public key fragment corresponding to the private key fragment may form a key pair. Data encrypted using the private key fragment saved by the client may be decrypted through the public key fragment corresponding to the private key fragment saved by the client. The public key fragment corresponding to the private key fragment saved by the client may be public. That is, the target business node may know the public key fragment corresponding to the private key fragment saved by the client. Therefore, the target business node may verify the second business signature in the first business (i.e., signature verification) using the public key fragment corresponding to the private key fragment saved by the client to obtain a verification result of the second business signature. If the verification result indicates that the second business signature is unsuccessfully verified, the first business is an illegal and untrusted business, and the target business node may start to process the first business. For example, the business information of the target type may be extracted from the first business. If the verification result indicates that the second business signature is successfully verified, the first business is a valid and trusted business.

The process in which the target business node verifies the second business signature to obtain a verification result of the second business signature may include the following operations. The target business node may decrypt the second business signature using the public key fragment corresponding to the private key fragment saved by the client to obtain a decrypted hash value. The target business node may further perform hash calculation on business information in the first business except the second business signature to obtain a calculated hash value. If the decrypted hash value is the same as (i.e., consistent with) the calculated hash value, the verification result of the second business signature may indicate that the second business signature is successfully verified. Otherwise, if the decrypted hash value is different from (i.e., inconsistent with) the calculated hash value, the verification result of the second business signature may indicate that the second business signature is unsuccessfully verified.

Operation S102: Invoke the local contract to perform information processing on the business information of the target type to obtain a processing result of the business information of the target type, and generate a transition business based on the processing result and other business information in the first business except the business information of the target type.

The target business node may invoke the local contract to perform information processing on the business information of the target type extracted from the first business to obtain the processing result of the business information of the target type. Illustratively, if the business information of the target type in the first business is the identity information of the client, the information processing may be identity authentication on the client, and the processing result may be an identity authentication result of the client. The target business node may invoke the local contract to perform identity authentication on the client based on the identity information of the client extracted from the first business to obtain the identity authentication result of the client. The identity authentication result may indicate that the identity of the client is valid, or the identity authentication result may indicate that the identity of the client is invalid (i.e., illegal).

Processing logic configured for performing information processing on the business information of the target type is configured in the local contract, and the processing logic may be pre-processing logic for the business. In some embodiments, the foregoing operation of extracting the business information of the target type from the first business in operation S101 may be performed by invoking the local contract, and processing logic configured for extracting the business information of the target type from the business may further be configured in the local contract. If the business information of the target type is the identity information of the client, the identity information of the client may contain identity number information of an object (for example, a user) to which the client belongs, and the identity number information is unique number information registered by the object in an institution. Therefore, the target business node may invoke the local contract to query the institution for the authenticity of the identity number information of the client. If it is found that the identity number information is number information of the object that really exists in the institution, it may be determined that the identity information of the client in the first business is valid. Otherwise, if it is found that the identity number information is not the number information of the object that really exists in the institution, it may be determined that the identity information of the client in the first business is illegal. The foregoing identity authentication result may be a processing result of the identity information (i.e., a processing result obtained after the local contract is invoked to perform information processing on the business information of the target type in the first business).

The target business node may generate a new business through the obtained processing result and other business information in the first business except the business information of the target type. The new business may be referred to as a transition business. The transition business may contain a processing result of the local contract on the business information of the target type. The processing result is used as an output of the local contract, and the output of the local contract may be used as a subsequent input of a business contract in the consensus node. The first business may contain a contract address invoked by the first business. The contract address invoked by the first business may be a contract address of the local contract of the foregoing target business node. The contract address may be a unique address (may be referred to as an invoking address of the local contract) allocated by the consensus network to the local contract when the local contract is deployed in the target business node. In addition, a business contract may further be deployed in the consensus network, for example, each consensus node in the consensus network may be deployed with the business contract. The business contract may be a contract for the consensus network to perform business processing (for example, including consensus on the business and execution of the business after consensus on the business succeeds). The consensus network performs business processing by invoking the business contract.

The process of generating a transition business based on the processing result of the business information of the target type in the first business and other business information in the first business except the business information of the target type may include the following operations.

The target business node may replace the business information of the target type in the first business with the processing result of the business information of the target type and may remove the second business signature in the first business (which may be understood as deleting the second business signature from the first business) to obtain an initial transition business. That is, a business obtained after the business information of the target type in the first business is replaced with the processing result of the business information of the target type and the second business signature is removed is referred to as the initial transition business. The initial transition business does not contain the business information of the target type but contains the processing result of the business information of the target type. In addition, the initial transition business does not contain the second business signature. A contract address invoked in the initial transition business is still the contract address of the local contract. The target business node may modify the contract address invoked in the initial transition business from the contract address of the local contract to a contract address of the business contract to generate the transition business. That is, a business obtained after the contract address invoked by the first business in the initial transition business is modified into the contract address of the business contract may be referred to as the transition business, and a contract address invoked in the transition business is the contract address of the business contract.

Since the business processed by the local contract may be transmitted to the consensus network to perform consensus, in the disclosure, a binding relationship between the local contract and a contract (for example, the foregoing business contract) that performs business processing on the business may be further established. The binding relationship may be established through the contract address of the local contract and the contract address of the business contract. For example, the binding relationship between the contract address of the local contract and the contract address of the business contract may be established. Therefore, the binding relationship may be established between the foregoing contract address of the local contract and the contract address of the business contract. The binding relationship may be established in a process of deploying the local contract in the target business node, or after deploying the local contract in the target business node. This is not limited.

The process in which the target business node modifies the contract address invoked by the first business in the initial transition business from the contract address of the local contract to the contract address of the business contract to generate the transition business may include the following operations.

The target business node may acquire a contract address (i.e., the contract address of the business contract) having a binding relationship with the contract address of the local contract and modify the contract address (i.e., the contract address of the local contract) invoked by the first business in the initial transition business to a contract address (i.e., the contract address of the business contract) having a binding relationship with the invoked contract address to obtain the transition business.

In some embodiments, the process of establishing the binding relationship between the contract address of the local contract and the contract address of the business contract may include the following operations.

The target business node may generate a contract binding business. The contract binding business may contain the contract address of the local contract and the contract address of the business contract. The contract binding business refers to a business configured for requesting to bind the contract address of the local contract and the contract address of the business contract (i.e., establishing a binding relationship). The target business node may transmit the contract binding business to the consensus network so that the consensus nodes in the consensus network may perform consensus on the contract binding business, and then execute the contract binding business after the consensus on the contract binding business succeeds.

Executing the contract binding business may be establishing the binding relationship between the contract address of the local contract and the contract address of the business contract. After successfully establishing the binding relationship between the contract address of the local contract and the contract address of the business contract (for example, after successfully executing the contract binding business), the consensus network may return state information of the contract binding business to the target business node. The state information of the contract binding business may be information indicating that the binding relationship between the contract address of the local contract and the contract address of the business contract is successfully established. The state information of the contract binding business may contain a contract address having a successfully established binding relationship with the contract address of the local contract. The target business node may store the contract address that is in the state information and has the binding relationship with the contract address of the local contract. The consensus network may further store an executed business (for example, the contract binding business) and an execution result (for example, the contract address having the binding relationship with the contract address of the local contract) of the contract binding business.

Generally, the target business node may store the contract address having the binding relationship with the contract address of the local contract. If the target business node stores the contract address having the binding relationship with the contract address of the local contract, the target business node may directly acquire the contract address having the binding relationship with the contract address of the local contract from a local database. Alternatively, in some special scenes (for example, a scene in which the local database of the target business node is faulty), if the target business node does not store the contract address having the binding relationship with the contract address of the local contract, the target business node may pull the contract address having the binding relationship with the contract address of the local contract from the consensus network (for example, to any consensus node).

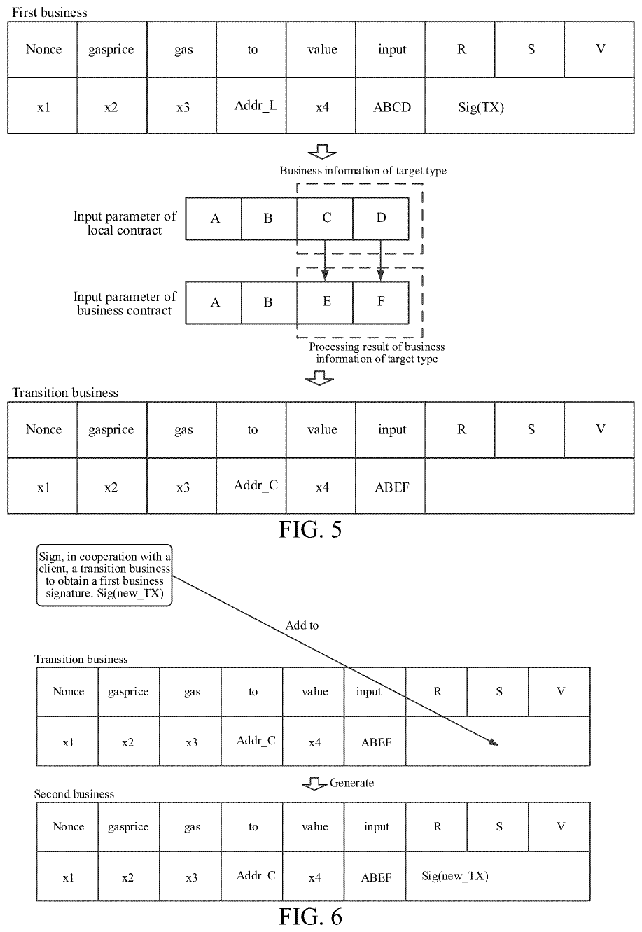

FIG. 5 is a schematic diagram of a scene of generating a transition business according to some embodiments. As shown in FIG. 5, one business may contain a plurality of fields. In this case, the plurality of fields in the first business may include: Nonce (a random number, which is x1 herein, filled in by the business initiator (such as the client)), gas price (which may be understood as the unit price of each operation in blockchain business processing, which is x2 herein), gas (which may be understood as the number of operations in blockchain business processing, which is x3 herein), to (representing a contract address invoked by the business, which is Addr_L herein, and Addr_L may represent the contract address of the local contract), value (if the business is a resource transfer business, the value is a resource transfer amount, which is x4 herein), input (input parameters, i.e., parameters for invoking a smart contract, which may include a parameter A, a parameter B, a parameter C, and a parameter D herein), and RSV (i.e., R, S, and V). These all represent signature fields of a business signature (the business signature herein is Sig(TX), and the Sig(TX) may represent the foregoing second business signature).

In the disclosure, the business information of the target type may be some parameters in the input parameters of the business. In this case, the business information of the target type in the first business may include the parameter C and the parameter D in the input parameters of the first business. Meanings represented by the parameters in the input parameters of the first business may be determined according to an actual application scene. This is not limited. In this way, the parameter C and the parameter D herein may be parameters representing the identity information of the client, and the parameter A and the parameter B may be related remark information during resource transfer, related information of a resource transferring party and a resource receiver, or the like.

The target business node may invoke the local contract to process the parameter C to obtain a result E (which may be referred to as a parameter E) and may invoke the local contract to process the parameter D to obtain a result F (which may be referred to as a parameter F). The result E and the result F form a processing result of the business information of the target type in the first business. The parameter A and the parameter B in the input parameters of the first business are kept unchanged, and the input parameters of the business contract may be the parameter A, the parameter B, the result E, and the result F. The input parameters are input parameters of the transition business that may be generated subsequently.

As shown in FIG. 5, the input parameters of the generated transition business may include the parameter A, the parameter B, the result E, and the result F, and a “to” field (i.e., a field of an invoked contract address) in the transition business may be Addr_C. The Addr_C may represent the contract address of the business contract. In the transition business, except the invoked contract address and the result E and the result F in the input parameters that are different from corresponding business information in the first business, other business information may be corresponding business information in the first business, and the signature field RSV in the transition business is null. Since the foregoing transition business is obtained after the target business node re-encapsulates the first business, the transition business may further be understood as a business of the target business node. However, essentially, the transition business is also the first business of the client.

Operation S103: Transmit the transition business to the client, and sign, in cooperation with the client, the transition business based on saved private key fragments to obtain a first business signature of the transition business.

The target business node may transmit the foregoing generated transition business to the client, and then sign, in cooperation with the client, the transition business based on the saved private key fragments to obtain a business signature of the transition business. The business signature may be referred to as the first business signature of the transition business. The first business signature is consistent with a signature obtained by directly signing the transition business (for example, encrypting a hash value of the transition business) using the node private key. However, the first business signature is obtained after the target business node, in cooperation with the client, encrypts the hash value of the transition business based on the saved private key fragments.

In some embodiments, in consideration of security, the target business node may sign the transition business (for example, encrypting the hash value of the transition business) using the private key fragment saved by the target business node to obtain a business signature of the transition business. The business signature may be referred to as a third business signature. Then, the third business signature and the transition business are transmitted to the client for cooperative signature processing.

The private key fragment saved by the target business node and a public key fragment corresponding to the private key fragment may form a key pair. That is, data encrypted using the private key fragment saved by the target business node may be decrypted through the public key fragment corresponding to the private key fragment saved by the target business node. The public key fragment corresponding to the private key fragment saved by the target business node may be public. Therefore, the client may know (or save) the public key fragment corresponding to the private key fragment saved by the target business node. After receiving the third business signature and the transition business, the client may verify the received third business signature (i.e., signature verification) through the public key fragment corresponding to the private key fragment saved by the target business node to obtain a verification result of the third business signature. The principle of verifying the third business signature through the public key fragment corresponding to the private key fragment saved by the target business node to obtain the verification result of the third business signature is the same as the foregoing principle of verifying the second business signature through the public key fragment corresponding to the private key fragment saved by the client to obtain the verification result of the second business signature.

If the verification result of the third business signature indicates that the third business signature is successfully verified, the client may sign, in cooperation with the target business node, the transition business so that the target business node may acquire the first business signature of the transition business.

In some embodiments, the process in which the target business node signs, in cooperation with the client, the transition business may include the following operations. Since the target business node is a node that submits the business to the consensus network, the transition business may be signed mainly by the target business node. After acquiring the transition business, the client may check business information in the transition business (for example, checking whether a format of the information is correct or whether the information is complete). After successfully verifying the business information in the transition business (for example, after confirming that the business information in the transition business is correct), the client may transmit an encrypted private key fragment to the target business node. The encrypted private key fragment may be obtained after the client performs homomorphic encryption on the private key fragment saved by the client. Homomorphic encryption is an encryption algorithm and has a characteristic of allowing a processing result of data after homomorphic encryption to be consistent with a processing result of original data (for example, the private key fragment saved by the client). After receiving the encrypted private key fragment transmitted by the client, the target business node may sign the transition business through the encrypted private key fragment and the private key fragment saved by the target business node (an achieved signature effect is consistent with an effect of directly signing the transition business using the node private key) to obtain the first business signature of the transition business.

In some embodiments, signing the transition business by the client is further supported. Similarly, the target business node may further perform homomorphic encryption on the private key fragment saved by the target business node to obtain a corresponding encrypted private key fragment and may transmit the encrypted private key fragment to the client. The client may further sign the transition business through the encrypted private key fragment combined with the private key fragment saved by the client to obtain a business signature (the same as the first business signature) of the transition business.

Operation S104: Generate a second business based on the first business signature and the transition business, and transmit the second business to the consensus network to cause the consensus network to perform consensus on the second business.

The target business node may combine the first business signature and the transition business to generate the second business. The second business contains the transition business and the first business signature of the transition business. In some embodiments, the transition business may contain a signature field, and field information at the signature field in the transition business is null, for example, no field information exists at the signature field in the transition business (for example, no business signature exists). Therefore, the first business signature may be encapsulated into the signature field in the transition business, for example, the first business signature is used as the field information at the signature field in the transition business, to obtain the second business. In other words, the second business is a business obtained after the first business signature is encapsulated into the transition business. The second business is a business that invokes the business contract. The invoking the business contract herein may further be understood as invoking a consensus network in which the business contract is deployed.

FIG. 6 is a schematic diagram of a scene of generating a second business according to some embodiments. As shown in FIG. 6, after the target business node signs, in cooperation with the client, the transition business to obtain the first business signature (i.e., Sig(new_TX) herein) of the transition business, the target business node may add the first business signature to a signature field RSV in the transition business to obtain the second business. The transition business herein may be generated based on the process described in the foregoing embodiment corresponding to FIG. 5. A contract address invoked by the second business is a contract address of a business contract. The target business node may transmit the second business to a consensus network so that the consensus network may perform consensus on the second business based on the deployed business contract.

In some embodiments, the consensus network may contain a plurality of consensus nodes, and the process in which the target business node transmits the second business to the consensus network may include the following operations. The target business node may transmit the second business to a target consensus node of the plurality of consensus nodes so that the target consensus node may further broadcast the received second business to other consensus nodes in the consensus network, and finally, each consensus node in the consensus network may receive the second business. In this way, the consensus nodes in the consensus network may collectively perform consensus on the second business based on the deployed business contract. Illustratively, the target consensus node may be any consensus node of the plurality of consensus nodes of the consensus network, or a consensus node that is closest (may be closest in a geographical location, which may enable a shorter data transmission line, lower data transmission overhead, and faster data transmission speed) to the target business node among the plurality of consensus nodes.

The second business may contain a processing result of business information of a target type. Therefore, after receiving the second business, the consensus node in the consensus network may check the processing result in the second business, and then perform consensus on the second business if it is determined that the processing result is a valid result (for example, the consensus node may confirm the processing result). For example, if the business information of the target type in the first business is identity information of the client, the processing result may be an identity authentication result of the client. Therefore, if the consensus node determines that the identity authentication result is a result of successfully authenticating an identity of the client (for example, a result of authenticating that the identity of the client is valid), the consensus node may perform consensus on the received second business.

In some embodiments, it can be learned from the foregoing that the first business signature is consistent with a signature obtained after directly encrypting a hash value of the transition business using a node private key. Therefore, any consensus node (any consensus node in the blockchain network may be the foregoing target consensus node or may not be the foregoing target consensus node) may invoke the business contract to perform consensus on the second business. Each consensus node may save a node public key (or referred to as a global public key) of the target business node, and the node public key and the node private key (or referred to as a global private key) of the target business node form a key pair. Based on the characteristics of the ECDSA m-n multi-signature algorithm, the node public key may be equal to a sum of public key fragments corresponding to private key fragments saved by parties (all clients with which the target business node is connected and the target business node) participating in key interaction. The node public key may be public.

A procedure in which any consensus node invokes the business contract to perform consensus on the second business may include the following operations. Any consensus node may invoke the business contract to verify the first business signature in the second business (i.e., signature verification) using the node public key of the target business node, including the following operations. Any consensus node may decrypt the first business signature in the second business using the node public key, and a hash value obtained by decryption may be referred to as a decrypted hash value. Any consensus node may further invoke the business contract to perform hash calculation on business information in the second business except the first business signature, and a hash value obtained by calculation may be referred to as a calculated hash value. Therefore, if the calculated hash value is consistent with (i.e., the same as) the decrypted hash value, it may be determined that the consensus of any consensus node on the second business succeeds (actually, the consensus process for the second business may further contain other consensus operations related to the second business, for example, when the second business is a resource transfer business, it is recommended to check whether the resources owned by the resource transferring party are sufficient to perform the corresponding number of resource transfers and other operations, which may be determined according to an actual application scene).

In some embodiments, when consensus of more than a specified number of consensus nodes (for example, more than 2f+1, where f is a positive integer and is the maximum number of malicious nodes that can be accommodated in the consensus network) in the consensus network on the second business succeeds, the consensus on the second business succeeds in the consensus network. The consensus network (i.e., the consensus node in the consensus network) may further invoke the business contract to execute the second business to obtain an execution result of the second business and may upload the second business and the execution result of the second business (for example, storing in the blockchain network). The consensus network (for example, the target consensus node in the consensus network) may return the execution result of the second business to the target business node, and the target business node may further store the execution result of the second business. For example, if the second business is a business of notarizing the target data, the execution result of the second business may be a result indicating that the target data has been successfully notarized. For another example, if the second business is a resource transfer business that transfers a target resource of the first account to the second account, the execution result of the second business may be a result indicating that the target resource of the first account has been transferred to the second account, and the like.

In some embodiments, the target business node may further associatively store the execution result of the second business, the first business (which may be an unmodified original first business transmitted by the client), and the second business.

In the disclosure, the processing logic of the local contract for information may be public, but the processing process (i.e., the execution process) of the local contract for the information is not public. Therefore, through the foregoing process, the business information of the target type may be enabled to exist only in the target business node (for example, exist only in the local contract of the target business node), and is not exposed to other blockchain nodes (for example, the consensus nodes) in the blockchain network. In this way, the business information of the target type is not disclosed. Therefore, the security and privacy of the business information of the target type in the business are further improved. In addition, in the disclosure, the business node may process the business information of the target type in the business through the local contract so that the consensus node does not may process the business information of the target type subsequently. Therefore, the target business node shares a part of the business processing workload of the consensus node, thereby reducing the load of the consensus node for the business processing. In addition, since the multi-signature algorithm is adopted in the disclosure, the client and the target business node each save the private key fragment of the node private key, and the business cannot be signed through the private key fragment saved by the client. Consequently, the client cannot bypass the target business node to directly transmit a business that has not been processed by the target business node (i.e., a business that has not been checked by the target business node) to the consensus node. Therefore, the security of business processing is further improved. In addition, according to the method provided in the disclosure, the local contract in the target business node may execute relatively complex business logic and add an execution result (for example, the processing result of the business information of the target type) to a business (for example, the first business initiated by the client). Further, an added business (for example, the transition business) may be confirmed by the target business node and the client (for example, confirmed through a process of cooperatively signing the transition business by the target business node and the client based on the saved private key fragments). Both a signature of the transition business by the target business node and a signature of the transition business by the client are reserved, thereby meeting a business rule submitted by the business to the consensus node and ensuring the security and credibility of the business.

In the disclosure, the blockchain network may contain the business network and the consensus network. The business network contains the target business node, and the local contract is deployed in the target business node. The local contract is configured for processing the business information of the target type in the business, and the business information of the target type refers to: business information that is not used in a process of performing consensus on a business by the consensus network, or business information that is not used in a process of executing the business after consensus on the business by the consensus network succeeds. The local contract is deployed in the target business node so that the target business node has a capability of processing the business information of the target type. The target business node has the node private key, the target business node and the client each save the private key fragment of the node private key, and the private key fragment of the node private key is obtained by performing key interaction between the target business node and the client. It can be learned that the target business node can perform key interaction with the client so that the target business node and the client each obtain and save the private key fragment of the node private key of the target business node. In this way, the node private key may perform distributed management on the target business node and the client, thereby improving the security of the node private key. The target business node may receive the first business transmitted by the client and extract the business information of the target type from the first business. The local contract is invoked to perform information processing on the extracted business information of the target type to obtain the processing result of the business information of the target type. Since deployment of the local contract enables the target business node to have the capability of processing the business information of the target type, the target business node may pre-process the first business (i.e., processing the business information of the target type in the first business in advance), and then provide the processing result of the business information of the target type to the consensus network, thereby alleviating the load pressure of business processing by the consensus network, and enabling the target business node and the consensus network to cooperate to perform business processing. The target business node generates the transition business based on the processing result and other business information in the first business except the business information of the target type. The transition business is transmitted to the client and signed, in cooperation with the client, based on the saved private key fragments to obtain the first business signature of the transition business. The second business is generated based on the first business signature and the transition business and transmitted to the consensus network to cause the consensus network to perform consensus on the second business. The processing result obtained by pre-processing the first business by the target business node changes the first business originally initiated by the client, and a new business (i.e., the transition business) is obtained. Therefore, the target business node may sign, in cooperation with the client, the new business based on the saved private key fragments to obtain a signature (i.e., the first business signature) of the new business. The second business may be generated through the new business and the signature of the new business and provided to the consensus network to perform consensus. A joint signature of the new business by the target business node and the client resolves the problem of confirming the new business, thereby improving the business processing performance of the blockchain network.

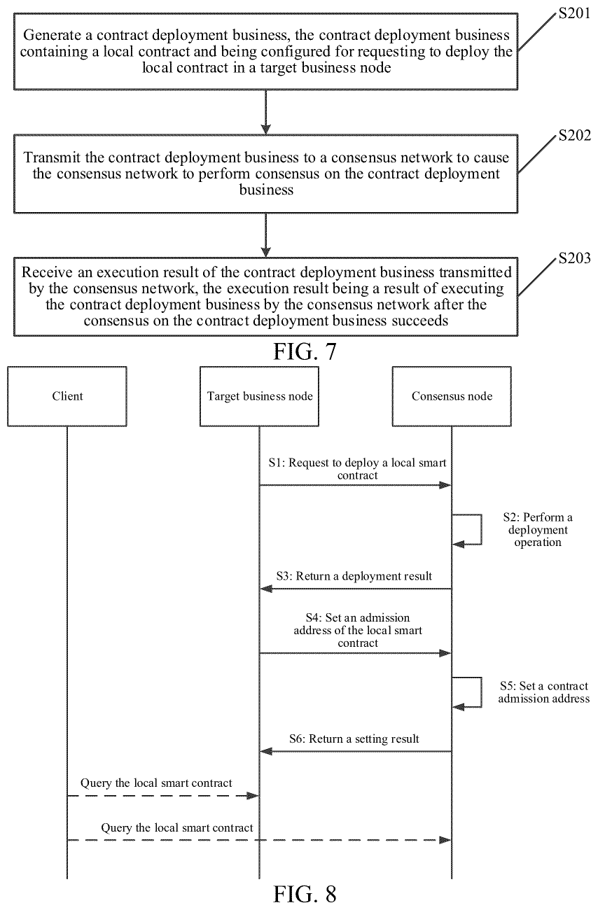

FIG. 7 is a schematic flowchart of a contract deployment method according to some embodiments. An execution subject in some embodiments may further be the foregoing target business node. As shown in FIG. 7, the method may include the following operations.

Operation S201: Generate a contract deployment business, the contract deployment business containing a local contract and being configured for requesting to deploy the local contract in a target business node.

The target business node may generate the contract deployment business. The contract deployment business may contain the foregoing local contract to be deployed (for example, contract code of the local contract may be contained). The local contract may be imported into the target business node or may be directly written in the target business node. This is not limited. The contract deployment business refers to a business configured for requesting to deploy the local contract in the target business node.

Operation S202: Submit the contract deployment business to a consensus network to cause the consensus network to perform consensus on the contract deployment business.

The target business node may transmit the foregoing generated contract deployment business to the consensus network (a principle may be the same as that of transmitting the second business to the consensus network) so that consensus nodes in the consensus network may perform consensus on the contract deployment business. If consensus on the contract deployment business succeeds in the consensus network, the consensus network (i.e., the consensus node in the consensus network) may execute the contract deployment business. Executing the contract deployment business may refer to: confirming that the local contract is successfully deployed in the target business node. After the contract deployment business is executed, an execution result of the contract deployment business may be obtained. The execution result may contain state information (for example, executed state information) of the contract deployment business. The state information may contain a local contract and be configured for indicating that the local contract is successfully deployed in the target business node.

In some embodiments, the target business node in the disclosure may have two private keys. One private key is the node private key mentioned above and is configured for performing key interaction between the target business node and the client to obtain a corresponding private key fragment so that the target business node may sign, in cooperation with the client to, a re-encapsulated business (for example, the transition business) of the client subsequently. The other private key may be referred to as a business private key of the target business node. The business private key may further have a corresponding public key (which may be referred to as a business public key). The business public key may be public. The business private key and the business public key may form a key pair. The business private key may be configured for signing a business (the business is usually irrelevant to the client, for example, the business may include the foregoing contract deployment business and the foregoing contract binding business) that is exclusive to the target business node. In some embodiments, after the target business node and the client perform key interaction on the node private key, a private key fragment saved by the target business node may be used as the foregoing business private key. Alternatively, the business private key may not be a private key fragment saved by the target business node for the node private key and may be additionally regenerated using a private key generation algorithm.

The consensus node in the consensus network may save the business public key of the target business node. The foregoing contract deployment business in the disclosure may carry a business signature of the contract deployment business, and the business signature may be obtained by signing other business information in the contract deployment business except the business signature by the target business node using the business private key. After acquiring the contract deployment business, the consensus node in the consensus network may verify the business signature in the contract deployment business (i.e., signature verification) using the foregoing business public key. If the verification succeeds and it is confirmed that the consensus on the contract deployment business succeeds in the consensus network, the contract deployment business may be executed to obtain the execution result of the contract deployment business.

Operation S203: Receive the execution result of the contract deployment business transmitted by the consensus network, the execution result being a result of executing the contract deployment business by the consensus network after the consensus on the contract deployment business succeeds.

The consensus network (i.e., the consensus node in the consensus network) may return the obtained execution result of the contract deployment business to the target business node. The target business node may acquire a successfully deployed local contract (i.e., synchronizing the deployed local contract from the consensus network) through the execution result of the contract deployment business and confirm that the local contract is successfully deployed at the target business node.

According to the foregoing method described in the disclosure, the local contract may be successfully deployed in the target business node in a business manner.

FIG. 8 is a schematic flowchart of deploying a local contract according to some embodiments. As shown in FIG. 8, the procedure may include the following operations.
S1: A target business node may request a consensus node to deploy a local smart contract (i.e., a local contract, for example, requesting through the foregoing contract deployment business), and code of the local smart contract may be included in the request.
S2: After receiving the request of the target business node, the consensus node (which may be any consensus node in a consensus network) may perform a deployment operation. A principle of performing the deployment operation may be performing consensus on the contract deployment business and executing the contract deployment business in the consensus network. The local contract may be successfully deployed in the target business node by performing the deployment operation.
S3: The consensus node may return a deployment result (which may be an execution result of the contract deployment business) of the local contract to the target business node so that the target business node may synchronize the successfully deployed local contract from the consensus node and then invoke the local contract subsequently.
S4: After learning that the local contract is successfully deployed, the target business node may further request the consensus node to set an admission address of the local contract. The admission address may be a public key fragment corresponding to a private key fragment saved by each client connected with the target business node and may be configured for subsequently verifying a business (for example, a first business) initiated by the client so that only a client whose public key fragment corresponding to the saved private key fragment is set to the admission address of the local contract can initiate a corresponding business (for example, the first business) to the target business node. That is, a business of invoking the local contract initiated by the client whose public key fragment corresponding to the saved private key fragment is set to the admission address of the local contract to the target business node can be successfully verified by the target business node, thereby performing information processing (for example, pre-processing the first business).
S5: After acquiring the request that is initiated by the target business node and configured for setting the admission address of the local contract, the consensus node may set the admission address for the local contract, for example, the public key fragment corresponding to the private key fragment saved by each client connected with the target business node is set as the admission address of the local contract. In some embodiments, the request may carry the public key fragment corresponding to the private key fragment saved by each client connected with the target business node.

In some embodiments, the foregoing process in which the target business node requests the consensus node to set the admission address of the local contract may be implemented by the target business node by initiating a business (which may be referred to as an admission address setting business) of setting the admission address of the local contract to the consensus node. After receiving the admission address setting business, the consensus node may perform consensus on the admission address setting business, and after the consensus on the admission address setting business succeeds in the consensus network, the consensus node may execute the admission address setting business. Executing the admission address setting business is to set the admission address of the local contract.
S6: The consensus node may return a setting result (for example, an execution result of the admission address setting business) to the target business node, and the target business node may learn that the admission address of the local contract is successfully set. Subsequently, only each client that participates in key interaction for the private key fragment of the node private key of the target business node (i.e., each client with which the target business node is connected) can invoke the local contract deployed in the target business node.

Subsequently, the client may query the local contract from the target business node or the consensus node so that the local contract deployed in the target business node is consistent with a local contract through consensus by the consensus nodes in the consensus network.

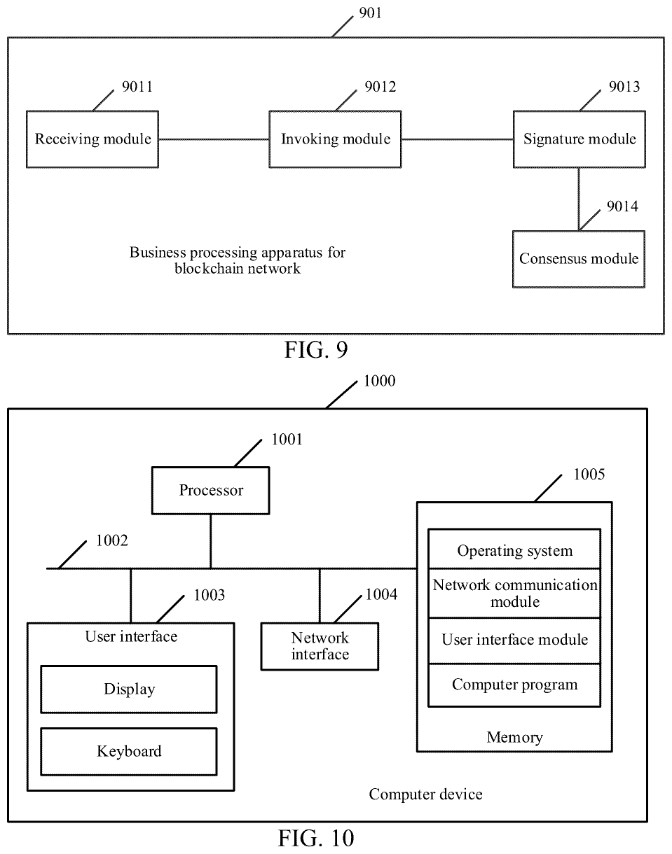

FIG. 9 is a schematic structural diagram of a business processing apparatus for a blockchain network according to some embodiments. The blockchain network contains a business network and a consensus network. The business network contains a target business node, and a local contract is deployed in the target business node. The local contract is configured for processing business information of a target type in the business. The business information of the target type is business information that is not witnessed by the consensus network, for example, the business information of the target type is business information that is not used in a process of performing consensus on a business by the consensus network, or business information that is not used in a process of executing the business after consensus on the business by the consensus network succeeds. The target business node has a node private key, and the target business node and the client each save a private key fragment, obtained through key interaction, of the node private key. The business processing apparatus for a blockchain network may be applied to the target business node. As shown in FIG. 9, a business processing apparatus 901 for a blockchain network may include: a receiving module 9011, an invoking module 9012, a signature module 9013, and a consensus module 9014.

The receiving module 9011 is configured to receive a first business transmitted by the client, and extract business information of a target type from the first business, the business information of the target type being business information that is not witnessed by a consensus network. No witness refers to: business information that is not used in a process of performing consensus on a business by the consensus network, or business information that is not used in a process of executing the business after consensus on the business by the consensus network succeeds.

The invoking module 9012 is configured to invoke the local contract to perform information processing on the business information of the target type to obtain a processing result of the business information of the target type, and generate a transition business based on the processing result and other business information in the first business except the business information of the target type.

The signature module 9013 is configured to transmit the transition business to the client, and sign, in cooperation with the client, the transition business based on saved private key fragments to obtain a first business signature of the transition business.

The consensus module 9014 is configured to generate a second business based on the first business signature and the transition business, and transmit the second business to the consensus network to cause the consensus network to perform consensus on the second business.

In some embodiments, the first business contains an invoked contract address, and the contract address invoked by the first business is a contract address of the local contract; a business contract is deployed in the consensus network, and the consensus network performs business processing by invoking the business contract; the first business contains a second business signature, and the second business signature is obtained after the client signs other business information in the first business except the second business signature based on the private key fragment saved by the client.

A manner in which the invoking module 9012 generates a transition business based on the processing result and other business information in the first business except the business information of the target type includes:

replacing the business information of the target type contained in the first business with the processing result, and removing the second business signature in the first business to obtain an initial transition business; and

modifying the contract address invoked by the first business in the initial transition business from the contract address of the local contract to the contract address of the business contract to generate the transition business.

In some embodiments, there is a binding relationship between the contract address of the local contract and the contract address of the business contract.

A manner in which the invoking module 9012 modifies the contract address invoked by the first business in the initial transition business from the contract address of the local contract to a contract address of the business contract to generate the transition business includes:

acquiring the contract address having the binding relationship with the contract address of the local contract; and

modifying the contract address invoked by the first business in the initial transition business from the contract address of the local contract to the contract address of the business contract having the binding relationship with the contract address of the local contract to generate the transition business.

In some embodiments, a manner in which the signature module 9013 signs, in cooperation with the client, the transition business based on saved private key fragments to obtain a first business signature of the transition business includes:

acquiring an encrypted private key fragment transmitted by the client, the encrypted private key fragment being transmitted by the client after successfully checking the transition business; and the encrypted private key fragment being obtained after the client performs homomorphic encryption on the private key fragment saved by the client; and

signing the transition business based on the encrypted private key fragment and the private key fragment saved by the target business node to obtain the first business signature of the transition business.

In some embodiments, the first business contains a second business signature, and the second business signature is obtained after the client signs other business information in the first business except the second business signature based on the private key fragment saved by the client.

A manner in which the receiving module 9011 extracts business information of a target type from the first business includes:

verifying the second business signature in the first business using a public key fragment corresponding to the private key fragment saved by the client to obtain a verification result of the second business signature; and

extracting the business information of the target type from the first business if the verification result of the second business signature is configured for indicating that the second business signature is successfully verified.

In some embodiments, a manner in which the signature module 9013 transmits the transition business to the client includes:

signing the transition business using the private key fragment saved by the target business node to obtain a third business signature of the transition business; and

transmitting the third business signature and the transition business to the client,

where the client is configured to verify a received third business signature based on a public key fragment corresponding to the private key fragment saved by the target business node and to sign, in cooperation with the target business node, the transition business after the third business signature is successfully verified.

In some embodiments, the transition business contains a signature field, and field information at the signature field in the transition business is null.

A manner in which the consensus module 9014 generates a second business based on the first business signature and the transition business includes:

encapsulating the first business signature into the signature field in the transition business to generate the second business.

In some embodiments, the business information of the target type contained in the first business is identity information of the client; the processing result is an identity authentication result of the client.

A manner in which the invoking module 9012 invokes the local contract to perform information processing on extracted business information of the target type to obtain a processing result of the business information of the target type includes:

invoking the local contract to perform identity authentication on the client based on extracted identity information of the client to obtain the identity authentication result of the client.

In some embodiments, the consensus network is configured to extract the identity authentication result from the second business after receiving the second business.

The consensus network is configured to perform consensus on the second business after determining, based on the identity authentication result, that an identity of the client initiating the second business is valid.

In some embodiments, the consensus network contains a plurality of consensus nodes. A manner in which the consensus module transmits the second business to the consensus network includes:

transmitting the second business to a target consensus node of the plurality of consensus nodes to cause the target consensus node to broadcast the second business to other consensus nodes of the plurality of consensus nodes,

where the target consensus node is any consensus node in the consensus network, and the plurality of consensus nodes in the consensus network are configured for performing consensus on a received second business.

In some embodiments, the first business signature is consistent with a business signature obtained after encrypting a hash value of the transition business using the node private key.

A procedure of performing, by any consensus node in the consensus network, consensus on the second business includes:

decrypting the first business signature in the second business using a node public key corresponding to the node private key to obtain a decrypted hash value;

performing hash calculation on other business information in the second business except the first business signature to obtain a calculated hash value; and

determining that the consensus of any consensus node on the second business succeeds if the calculated hash value is consistent with the decrypted hash value.

In some embodiments, the foregoing apparatus 901 is further configured to:

generate a contract deployment business, the contract deployment business containing the local contract and being configured for requesting to deploy the local contract in the target business node;

transmit the contract deployment business to the consensus network to cause the consensus network to perform consensus on the contract deployment business; and

receive an execution result of the contract deployment business transmitted by the consensus network, the execution result being a result of executing the contract deployment business by the consensus network after the consensus on the contract deployment business succeeds,

where the execution result of the contract deployment business contains state information of the contract deployment business, and the state information contains the local contract and is configured for indicating that the local contract is successfully deployed.

In some embodiments, the foregoing apparatus 901 is further configured to:

receive an execution result of the second business transmitted by the consensus network, the execution result being a result of executing the second business by the consensus network after the consensus on the second business succeeds; and

associatively store the execution result of the second business, the first business, and the second business.

According to some embodiments, the operations involved in the business processing method for a blockchain network shown in FIG. 3 may be performed by the modules in the business processing apparatus 901 for a blockchain network shown in FIG. 9. For example, operation S101 shown in FIG. 3 may be performed by the receiving module 9011 shown in FIG. 9, and operation S102 shown in FIG. 3 may be performed by the invoking module 9012 shown in FIG. 9. Operation S103 shown in FIG. 3 may be performed by the signature module 9013 shown in FIG. 9, and operation S104 shown in FIG. 3 may be performed by the consensus module 9014 shown in FIG. 9.

In the disclosure, the blockchain network may contain the business network and the consensus network. The business network contains the target business node, and the local contract is deployed in the target business node. The local contract is configured for processing the business information of the target type in the business, and the business information of the target type refers to: business information that is not used in a process of performing consensus on a business by the consensus network, or business information that is not used in a process of executing the business after consensus on the business by the consensus network succeeds. The local contract is deployed in the target business node so that the target business node has a capability of processing the business information of the target type. The target business node has the node private key, the target business node and the client each save the private key fragment of the node private key, and the private key fragment of the node private key is obtained by performing key interaction between the target business node and the client. It can be learned that the target business node can perform key interaction with the client so that the target business node and the client each obtain and save the private key fragment of the node private key of the target business node. In this way, the node private key may perform distributed management on the target business node and the client, thereby improving the security of the node private key. The target business node may receive the first business transmitted by the client and extract the business information of the target type from the first business. The local contract is invoked to perform information processing on the extracted business information of the target type to obtain the processing result of the business information of the target type. Since deployment of the local contract enables the target business node to have the capability of processing the business information of the target type, the target business node may pre-process the first business (i.e., processing the business information of the target type in the first business in advance), and then provide the processing result of the business information of the target type to the consensus network, thereby alleviating the load pressure of business processing by the consensus network, and enabling the target business node and the consensus network to cooperate to perform business processing. The target business node generates the transition business based on the processing result and other business information in the first business except the business information of the target type. The transition business is transmitted to the client and signed, in cooperation with the client, based on the saved private key fragments to obtain the first business signature of the transition business. The second business is generated based on the first business signature and the transition business and transmitted to the consensus network to cause the consensus network to perform consensus on the second business. The processing result obtained by pre-processing the first business by the target business node changes the first business originally initiated by the client, and a new business (i.e., the transition business) is obtained. Therefore, the target business node may sign, in cooperation with the client, the new business based on the saved private key fragments to obtain a signature (i.e., the first business signature) of the new business. The second business may be generated through the new business and the signature of the new business and provided to the consensus network to perform consensus. A joint signature of the new business by the target business node and the client resolves the problem of confirming the new business, thereby improving the business processing performance of the blockchain network.

According to some embodiments, the modules in the business processing apparatus 901 for a blockchain network shown in FIG. 9 may be separately or wholly combined into one or several units, or one (or more) of the units herein may further be divided into a plurality of sub-units with smaller functions. In this way, the same operations may be implemented, and the implementation of the technical effects of some embodiments is not affected. The foregoing modules are divided based on logical functions. In actual application, a function of one module may further be implemented by a plurality of units, or functions of a plurality of modules are implemented by one unit. In other embodiments of the disclosure, the business processing apparatus 901 for a blockchain network may further include other units. In actual application, these functions may be cooperatively implemented by other units, and may be cooperatively implemented by a plurality of units.

According to some embodiments, a computer program that can perform the operations involved in the corresponding method shown in FIG. 3 may be run on a general-purpose computer device such as a computer including processing elements such as a central processing unit (CPU), a random access medium (RAM), and a read-only medium (ROM) as well as storage elements to construct the business processing apparatus 901 for a blockchain network shown in FIG. 9 and implement the business processing method for a blockchain network in some embodiments. The foregoing computer program may be recorded in, for example, a computer-readable recording medium, and may be loaded into the foregoing computing device through the computer-readable recording medium and run in the computing device.

FIG. 10 is a schematic structural diagram of a computer device according to some embodiments. As shown in FIG. 10, a computer device 1000 may include: a processor 1001, a network interface 1004, and a memory 1005. In addition, in some embodiments, the computer device 1000 may further include: a user interface 1003 and at least one communication bus 1002. The communication bus 1002 is configured to implement the connection and communication among the components. The user interface 1003 may include a display and a keyboard. In some embodiments, the user interface 1003 may further include a standard wired interface and a standard wireless interface. In some embodiments, the network interface 1004 may include a standard wired interface and a standard wireless interface (such as a WI-FI interface). The memory 1005 may be a high-speed RAM, or may be a non-volatile memory, for example, at least one magnetic disk storage. In some embodiments, the memory 1005 may be at least one storage apparatus away from the foregoing processor 1001. As shown in FIG. 10, as a computer storage medium, the memory 1005 may include an operating system, a network communication module, a user interface module, and a computer program.

In the computer device 1000 shown in FIG. 10, the network interface 1004 may provide a network communication function. The user interface 1003 may be configured to provide an input interface for a user. The processor 1001 may be configured to invoke the computer program stored in the memory 1005 to implement the implementations provided in the foregoing operations shown in FIG. 3 and FIG. 8. Details may refer to the implementations provided in the foregoing operations and will not be described herein again. The computer device 1000 described in some embodiments may perform the descriptions of the foregoing business processing method for a blockchain network in some embodiments corresponding to FIG. 3 to FIG. 8 or perform the descriptions of the foregoing business processing apparatus 901 for a blockchain network in some embodiments corresponding to FIG. 9. Details are not described herein again. In addition, the description of beneficial effects of the same method are not described herein again.

In addition, the disclosure further provides a computer-readable storage medium, having a computer program stored therein. When executing the computer program, a processor can perform the descriptions of the business processing method for a blockchain network in some embodiments corresponding to FIG. 3. In addition, the description of beneficial effects of the same method are not described herein again. Technical details that are not disclosed in the computer storage medium embodiment of the disclosure may refer to the descriptions of the method embodiments of the disclosure.

As an example, the foregoing computer program may be deployed to be executed on one computer device, on a plurality of computer devices located at one place, or on a plurality of computer devices distributed at a plurality of places and interconnected through a communication network. The plurality of computer devices distributed at the plurality of places and interconnected through the communication network may form a blockchain network.

The foregoing computer-readable storage medium may be an internal storage unit of the foregoing computer device, for example, a hard disk or memory of the computer device. The computer-readable storage medium may be an external storage device of the computer device, for example, a plug-in hard disk, a smart media card (SMC), a secure digital (SD) card, and a flash card that are equipped in the computer device. Further, the computer-readable storage medium may further include both the internal storage unit and the external storage device of the computer device. The computer-readable storage medium is configured to store the computer program and other programs and data that are obtained by the computer device. The computer-readable storage medium may further be configured to temporarily store data that has been outputted or is to be outputted.

The disclosure provides a computer program product, including a computer program, the computer program being stored in a computer-readable storage medium. A processor of a computer device reads the computer program from the computer-readable storage medium, and the processor executes the computer program to cause the computer device to perform the descriptions of the foregoing business processing method for a blockchain network in some embodiments corresponding to FIG. 3. In addition, the description of beneficial effects of the same method are not described herein again. Technical details that are not disclosed in the computer-readable storage medium embodiment of the disclosure may refer to the descriptions of the method embodiments of the disclosure.

In the specification, claims, and accompanying drawings of some embodiments, the terms “first”, “second”, and so on are intended to distinguish different objects but do not indicate a order. In addition, the term “include” and any variant thereof are intended to cover a non-exclusive inclusion. For example, processes, methods, apparatuses, products, or devices containing a series of steps or units are not limited to the listed steps or units, but include steps or units that are not listed, or include other steps or units that are inherent to these processes, methods, apparatuses, products, or devices.

A person skilled in the art may realize that the units and algorithm steps in the example described in conjunction with some embodiments disclosed herein may be implemented in electronic hardware, computer software, or a combination of the two. To clearly illustrate the interchangeability of hardware and software, the composite and steps of the examples have been described above generally according to functions. Whether these functions are implemented in hardware or software depends on the application and design constraints of the technical solutions. For each application, a person skilled in the art may use different methods to achieve the described function, but this implementation shall not be considered outside the scope of the disclosure.

What is disclosed above is merely exemplary embodiments of the disclosure, and certainly is not intended to limit the scope of the claims of the disclosure. Therefore, equivalent variations made in accordance with the claims of the disclosure shall fall within the scope of the disclosure.

According to some embodiments, each module or unit may exist respectively or be combined into one or more units. Some units may be further split into multiple smaller function subunits, thereby implementing the same operations without affecting the technical effects of some embodiments. The units are divided based on logical functions. In actual applications, a function of one unit may be realized by multiple units, or functions of multiple units may be realized by one unit. In some embodiments, the apparatus may further include other units. These functions may also be realized cooperatively by the other units, and may be realized cooperatively by multiple units.

A person skilled in the art would understand that these “modules” could be implemented by hardware logic, a processor or processors executing computer software code, or a combination of both. The “modules” may also be implemented in software stored in a memory of a computer or a non-transitory computer-readable medium, where the instructions of each module are executable by a processor to thereby cause the processor to perform the respective operations of the corresponding module.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A method for transaction processing in a blockchain network, performed by a computer device, the method comprising:
receiving, from a target processing node in a processing network of the blockchain network, a first transaction transmitted by a client;
extracting, from the first transaction, information of a target type comprising information that is not used during consensus processing by a consensus network of the blockchain network or during execution after successful consensus;
invoking a local contract deployed in the target processing node to perform information processing on the information of the target type to obtain a processing result;
generating a transition transaction based on the processing result and other information from the first transaction excluding the information of the target type;
transmitting the transition transaction to the client;
signing, in cooperation with the client, the transition transaction based on private key fragments stored in the client and the target processing node to obtain a first transaction signature; and
generating a second transaction based on the first transaction signature and the transition transaction, and
transmitting the second transaction to the consensus network to initiate the consensus network to perform consensus on the second transaction.

2. The method according to claim 1,
wherein the first transaction comprises a contract address associated with the local contract,
wherein a transaction contract is deployed in the consensus network for performing transaction processing;
wherein the first transaction comprises a second transaction signature obtained after the client signs information in the first transaction excluding the second transaction signature based on the private key fragment stored in the client; and
wherein the generating a transition transaction comprises:
replacing the information of the target type in the first transaction with the processing result;
removing the second transaction signature from the first transaction to obtain an initial transition transaction; and
modifying the contract address in the initial transition transaction from the contract address of the local contract to a contract address of the transaction contract to generate the transition transaction.

3. The method according to claim 2,
wherein a binding relationship exists between the contract address of the local contract and the contract address of the transaction contract,
wherein the modifying the contract address comprises:
acquiring the contract address of the transaction contract having the binding relationship with the contract address of the local contract; and
modifying the contract address in the initial transition transaction from the contract address of the local contract to the contract address of the transaction contract to generate the transition transaction.

4. The method according to claim 1,
wherein the signing, in cooperation with the client, the transition transaction comprises:
acquiring an encrypted private key fragment from the client based on the client successfully verifying the transition transaction,
wherein the encrypted private key fragment is obtained based on the client performing homomorphic encryption on the private key fragment stored in the client; and
signing the transition transaction based on the encrypted private key fragment and the private key fragment stored in the target processing node to obtain the first transaction signature of the transition transaction.

5. The method according to claim 1,
wherein the first transaction comprises the second transaction signature obtained based on the client signing the information in the first transaction excluding the second transaction signature with the private key fragment stored in the client,
wherein the extracting transaction information comprises:
verifying the second transaction signature in the first transaction based on a public key fragment corresponding to the private key fragment stored in the client to obtain a verification result; and
extracting the transaction information of the target type from the first transaction based on the verification result indicating successful verification of the second transaction signature.

6. The method according to claim 1,
wherein the transmitting the transition transaction to the client comprises:
signing the transition transaction based on the private key fragment stored in the target processing node to obtain a third transaction signature of the transition transaction; and
transmitting the third transaction signature and the transition transaction to the client,
wherein the client verifies the received third transaction signature based on a public key fragment corresponding to the private key fragment stored in the target processing node,
wherein the client signs, in cooperation with the target processing node, the transition transaction after successful verification of the third transaction signature.

7. The method according to claim 1,
wherein the transition transaction comprises a signature field, and field information at the signature field in the transition transaction is null,
wherein the generating a second transaction comprises:
encapsulating the first transaction signature into the signature field in the transition transaction to generate the second transaction.

8. The method according to claim 1,
wherein the transaction information of the target type in the first transaction comprises identity information of the client,
wherein the processing result comprises an identity authentication result of the client,
wherein the invoking the local contract comprises:
invoking the local contract to perform identity authentication on the client based on the extracted identity information of the client to obtain the identity authentication result of the client.

9. The method according to claim 8, further comprising:
extracting, by the consensus network, the identity authentication result from the second transaction base on receiving the second transaction; and
performing, by the consensus network, consensus on the second transaction based on determining, based on the identity authentication result, that an identity of the client initiating the second transaction is valid.

10. The method according to claim 1,
wherein the consensus network comprises a plurality of consensus nodes,
wherein the transmitting the second transaction to the consensus network comprises:
transmitting the second transaction to a target consensus node of the plurality of consensus nodes,
wherein the target consensus node broadcasts the second transaction to other consensus nodes among the plurality of consensus nodes,
wherein the target consensus node is a consensus node in the consensus network, and the plurality of consensus nodes in the consensus network are configured to perform consensus on a received second transaction.

11. The method according to claim 1,
wherein the first transaction signature is consistent with a transaction signature obtained based on encrypting a hash value of the transition transaction with a node private key,
wherein performing consensus on the second transaction by a consensus node in the consensus network comprises:
decrypting the first transaction signature in the second transaction based on a node public key corresponding to the node private key to obtain a decrypted hash value;
performing hash calculation on information in the second transaction excluding the first transaction signature to obtain a calculated hash value; and
determining that the consensus on the second transaction succeeds based on the calculated hash value matching with the decrypted hash value.

12. The method according to claim 1, further comprising:
generating a contract deployment transaction comprising the local contract and requesting deployment of the local contract in the target processing node;
transmitting the contract deployment transaction to the consensus network to initiate the consensus network to perform consensus on the contract deployment transaction; and
receiving an execution result of the contract deployment transaction from the consensus network,
wherein the execution result is a result of executing the contract deployment transaction by the consensus network based on a successful consensus on the contract deployment transaction,
wherein the execution result comprises state information of the contract deployment transaction, and
wherein the state information comprises the local contract and indicates successful deployment of the local contract.

13. The method according to claim 1, further comprising:
receiving an execution result of the second transaction from the consensus network,
wherein the execution result is a result of executing the second transaction by the consensus network based on successful consensus on the second transaction; and
storing associatively the execution result of the second transaction, the first transaction, and the second transaction.

14. An apparatus for transaction processing in a blockchain network, comprising:
at least one memory configured to store program code; and
at least one processor configured to read the program code and operate as instructed by the program code, the program code comprising:
receiving code configured to cause at least one of the at least one processor to receive, from a target processing node in a processing network of the blockchain network, a first transaction transmitted by a client;
extracting code configured to cause at least one of the at least one processor to extract, from the first transaction, information of a target type comprising information that is not used during consensus processing by a consensus network of the blockchain network or during execution after successful consensus;
invoking code configured to cause at least one of the at least one processor to invoke a local contract deployed in the target processing node to perform information processing on the information of the target type to obtain a processing result;
generating code configured to cause at least one of the at least one processor to generate a transition transaction based on the processing result and other information from the first transaction excluding the information of the target type;
transmitting code configured to cause at least one of the at least one processor to transmit the transition transaction to the client;
signing code configured to cause at least one of the at least one processor to sign, in cooperation with the client, the transition transaction based on private key fragments stored in the client and the target processing node to obtain a first transaction signature; and
transaction code configured to cause at least one of the at least one processor to generate a second transaction based on the first transaction signature and the transition transaction, and transmit the second transaction to the consensus network to initiate the consensus network to perform consensus on the second transaction.

15. The apparatus according to claim 14,
wherein the first transaction comprises a contract address associated with the local contract,
wherein a transaction contract is deployed in the consensus network for performing transaction processing;
wherein the first transaction comprises a second transaction signature obtained after the client signs information in the first transaction excluding the second transaction signature based on the private key fragment stored in the client; and
wherein the generating code is further configured to cause at least one of the at least one processor to:
replace the information of the target type in the first transaction with the processing result;
remove the second transaction signature from the first transaction to obtain an initial transition transaction; and
modify the contract address in the initial transition transaction from the contract address of the local contract to a contract address of the transaction contract to generate the transition transaction.

16. The apparatus according to claim 15,
wherein a binding relationship exists between the contract address of the local contract and the contract address of the transaction contract,
wherein the generating code is further configured to cause at least one of the at least one processor to:
acquire the contract address of the transaction contract having the binding relationship with the contract address of the local contract; and
modify the contract address in the initial transition transaction from the contract address of the local contract to the contract address of the transaction contract to generate the transition transaction.

17. The apparatus according to claim 14,
wherein the signing code is further configured to cause at least one of the at least one processor to:
acquire an encrypted private key fragment from the client based on the client successfully verifying the transition transaction,
wherein the encrypted private key fragment is obtained based on the client performing homomorphic encryption on the private key fragment stored in the client; and
sign the transition transaction based on the encrypted private key fragment and the private key fragment stored in the target processing node to obtain the first transaction signature of the transition transaction.

18. The apparatus according to claim 14,
wherein the first transaction comprises the second transaction signature obtained based on the client signing the information in the first transaction excluding the second transaction signature with the private key fragment stored in the client,
wherein the extracting code is further configured to cause at least one of the at least one processor to:
verify the second transaction signature in the first transaction based on a public key fragment corresponding to the private key fragment stored in the client to obtain a verification result; and
extract the transaction information of the target type from the first transaction based on the verification result indicating successful verification of the second transaction signature.

19. The apparatus according to claim 14,
wherein the transmitting code is further configured to cause at least one of the at least one processor to:
sign the transition transaction based on the private key fragment stored in the target processing node to obtain a third transaction signature of the transition transaction; and
transmit the third transaction signature and the transition transaction to the client,
wherein the client verifies the received third transaction signature based on a public key fragment corresponding to the private key fragment stored in the target processing node,
wherein the client signs, in cooperation with the target processing node, the transition transaction after successful verification of the third transaction signature.

20. A non-transitory computer-readable storage medium, storing computer code which, when executed by at least one processor, causes the at least one processor to at least:
receive, from a target processing node in a processing network of a blockchain network, a first transaction transmitted by a client;
extract, from the first transaction, information of a target type comprising information that is not used during consensus processing by a consensus network of the blockchain network or during execution after successful consensus;
invoke a local contract deployed in the target processing node to perform information processing on the information of the target type to obtain a processing result;
generate a transition transaction based on the processing result and other information from the first transaction excluding the information of the target type;
transmit the transition transaction to the client;
sign, in cooperation with the client, the transition transaction based on private key fragments stored in the client and the target processing node to obtain a first transaction signature; and
generate a second transaction based on the first transaction signature and the transition transaction, and
transmit the second transaction to the consensus network to initiate the consensus network to perform consensus on the second transaction.
